(19) United States
(12) Patent Application Publication
(10) Pub. No.: US 2019/0034314 A1
(43) Pub. Date: Jan. 31, 2019

(54) SIMULATION APPARATUS

(71) Applicant: MITSUBISHI ELECTRIC CORPORATION, Tokyo (JP)

(72) Inventors: Daisuke OGAWA, Tokyo (JP); Osamu TOYAMA, Tokyo (JP); Tetsuya TAKEO, Tokyo (JP); Koji NISHIKAWA, Tokyo (JP)

(73) Assignee: MITSUBISHI ELECTRIC CORPORATION, Tokyo (JP)

(21) Appl. No.: 16/070,236

(22) PCT Filed: Mar. 1, 2016
(86) PCT No.: PCT/JP2016/056198

§ 371 Date: Jul. 13, 2018

(51) Int. Cl. G06F 11/34; G06F 11/30

(52) U.S. Cl. CPC G06F 11/3457; G06F 11/3024

(57) ABSTRACT

A simulation apparatus of a multi-core model according to the present invention includes: a plurality of processor core models that each executes an instruction being input; a processing time calculator that calculates time at which each of the plurality of processor core models executes the instruction as processing time; a scheduler that selects a processor core model to be executed next from among the plurality of processor core models on the basis of the processing time calculated by the processing time calculator; and an overall time holding unit that holds processing time of the entire simulation apparatus determined from the processing time calculated by the processing time calculator, where the processor core model selected by the scheduler executes a next instruction in accordance with a direction from the scheduler. Such a configuration can maintain accuracy of synchronization among multiple CPUs or multiple cores and perform an accurate performance evaluation while executing the multiple CPUs or multiple cores with different execution accuracies.

### TECHNICAL FIELD

The present invention relates to a simulation apparatus that performs a simulation.

### BACKGROUND ART

There is a simulation apparatus that performs a simulation to develop and verify a system composed of hardware (hereinafter referred to as HW) including a plurality of central processing units (hereinafter referred to as multiple CPUs) or a plurality of cores (hereinafter referred to as multiple cores) and software (hereinafter referred to as SW) that runs on the HW. The simulation apparatus concurrently operates a HW model which describes the HW on a system to be verified (hereinafter referred to as a target system) in a C-based system level design language and a target code which is the SW running on the multiple CPUs or cores to be a target, thereby verifying the operation.

FIG. 15 illustrates the configuration of the simulation apparatus. A simulator apparatus 6000 includes a CPU core 0 model 6001, a CPU core 1 model 6002, a CPU bus model 6003, an external I/O model 6004, a peripheral model 6005, and a memory model 6006. An SW model 7000 runs on the simulation apparatus 6000. Note that each model in FIG. 15 is a functional model modeled using a high-level language such as C language on the simulation apparatus 6000 and is not hardware itself.

The CPU core 0 model 6001 in the simulation apparatus 6000 is implemented by an instruction set simulator (hereinafter referred to as an ISS), which executes the target code. The ISS executes the target code by converting the target code into an instruction code (hereinafter referred to as a host code) for a host machine or host CPU on which the simulation apparatus 6000 operates.

The simulation apparatus 6000 executes the target code of the CPU core 0 model 6001 and the CPU core 1 model 6002 while synchronizing the two. The simulation apparatus 6000 synchronizes the CPU core 0 model 6001 and the CPU core 1 model 6002 on the basis of time on the host machine or host CPU (such time will be hereinafter referred to as host CPU time). The simulation apparatus 6000 switches execution of the target code between the CPU core 0 model 6001 and the CPU core 1 model 6002 when a certain period of the host CPU time elapses.

FIG. 16 illustrates the timing of the simulation apparatus 6000. FIG. 16 illustrates, on the upper side, the run time of the CPU core 0 model 6001 and the CPU core 1 model 6002 in terms of the host CPU time and, on the lower side, the run time of the CPU core 0 model 6001 and the CPU core 1 model 6002 in terms of target CPU time. Here, Hx (x=0, 1, 2, 3, . . . ) represents the host CPU time, and Tx (x=0, 1, 2, 3, . . . ) represents the target CPU time.

When the run time of the simulation apparatus 6000 is viewed in terms of the host CPU time, the CPU core 0 model 6001 and the CPU core 1 model 6002 each execute processing until a certain period of time elapses in the host CPU time, whereby the processing times of the CPU core 0 model 6001 and the CPU core 1 model 6002 appear to be equal to each other.

On the other hand, in terms of the target CPU time, the target CPU times of the CPU core 0 model 6001 and the CPU core 1 model 6002 are not necessarily equal due to the operating frequency, instruction execution cycle, and processing details of each of the CPU core 0 model 6001 and the CPU core 1 model 6002. The CPU core 0 model 6001 and the CPU core 1 model 6002 are thus synchronized at a timing different from that of the target system including the multiple cores or multiple CPUs, thereby causing a problem that the operation of the target system cannot be simulated accurately.

Patent Literature 1 discloses a technique for performing a simulation on a plurality of CPU core models that executes a plurality of threads while synchronizing the plurality of CPU core models. Patent Literature 1 synchronizes the plurality of CPU core models by concurrently executing the plurality of CPU core models while allocating one thread to each of the plurality of CPU core models, and causing the CPU core models to shift to a standby state after execution of a predetermined number of execution instructions in the thread. As described above, Patent Literature 1 runs one thread in one CPU core model and shifts the CPU core model to the standby state after execution of the specific number of execution instructions to synchronize the CPU core models with the instructions of the target CPU, thereby solving the above problem and simulating the target system including the multiple cores.

### CITATION LIST

### Patent Literature

Patent Literature 1: JP 4717492 B2

### SUMMARY OF INVENTION

### Technical Problem

In the conventional technique described in Patent Literature 1, the plurality of CPU core models performs synchronization thereamong by shifting to the standby state after executing the common number of instructions. The conventional technique is thus inapplicable to a case where the cores execute different numbers of instructions by different time units, a case where the cores are run with different operating frequencies, and the like, thereby having a problem that the technique cannot be applied to a model that runs the cores with different execution accuracies. That is, the conventional technique has a problem of difficulty in maintaining accuracy of synchronization among the multiple CPUs or multiple cores and performing an accurate performance evaluation while executing the multiple CPUs or multiple cores with different execution accuracies.

The present invention has been made in order to solve the above problems, and an object of the present invention is to provide a multi-core simulation apparatus that ensures accuracy of synchronization among multiple CPUs or multiple cores and performs an accurate performance evaluation even when executing the multiple CPUs or multiple cores with different execution accuracies in simulating a system including the multiple CPUs or multiple cores.

### Solution to Problem

A simulation apparatus of a multi-core model according to the present invention includes: a plurality of processor core models to each execute an instruction being input; a processing time calculator to calculate time at which each of the plurality of processor core models executes the instruction as processing time; a scheduler to select a processor core model to be executed next from among the plurality of processor core models on the basis of the processing time calculated by the processing time calculator; and an overall time holding unit to hold processing time of the entire simulation apparatus determined from the processing time calculated by the processing time calculator, wherein the processor core model selected by the scheduler executes a next instruction in accordance with a direction from the scheduler.

### Advantageous Effects of Invention

The simulation apparatus according to the present invention can maintain the accuracy of synchronization among the multiple CPUs or multiple cores and perform an accurate performance evaluation while executing the multiple CPUs or multiple cores with different execution accuracies in simulating the system including the multiple CPUs or multiple cores.

### BRIEF DESCRIPTION OF DRAWINGS

FIG. 1 is a functional block diagram illustrating the configuration of a simulation apparatus according to a first embodiment.

FIG. 2 is a functional block diagram illustrating an instruction input controller according to the first embodiment.

FIG. 3 is a functional block diagram illustrating a processing time calculator according to the first embodiment.

FIG. 4 is a functional block diagram illustrating a scheduler according to the first embodiment.

FIG. 5 is a flowchart illustrating overall processing according to the first embodiment.

FIG. 6 is a flowchart illustrating the operation of instruction input control according to the first embodiment.

FIG. 7 is a table illustrating the operation of a multi-core simulation according to the first embodiment.

FIG. 8 is a diagram illustrating the operation of the multi-core simulation according to the first embodiment.

FIG. 9 is a block diagram of hardware implementing the simulation apparatus according to the first embodiment.

FIG. 10 is a functional block diagram illustrating the instruction input controller according to a second embodiment.

FIG. 11 is a flowchart illustrating the operation of instruction input control according to the second embodiment.

FIG. 12 is a functional block diagram illustrating the configuration of the simulation apparatus according to a third embodiment.

FIG. 13 is a functional block diagram illustrating the instruction input controller according to the third embodiment.

FIG. 14 is a flowchart illustrating the operation of instruction input control according to the third embodiment.

FIG. 15 is a diagram illustrating the configuration of a conventional simulation apparatus.

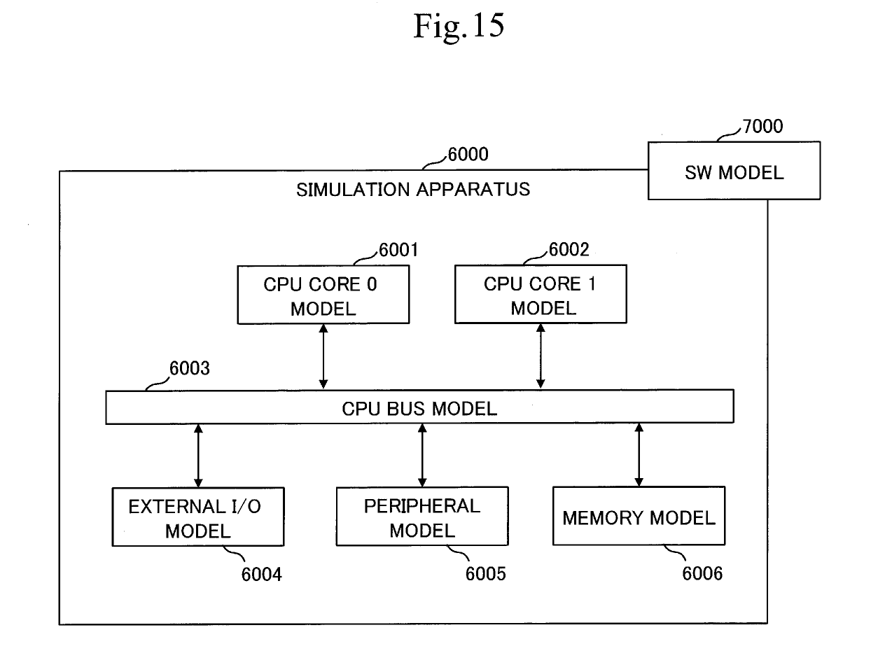

FIG. 16 is a timing diagram of the conventional simulation apparatus.

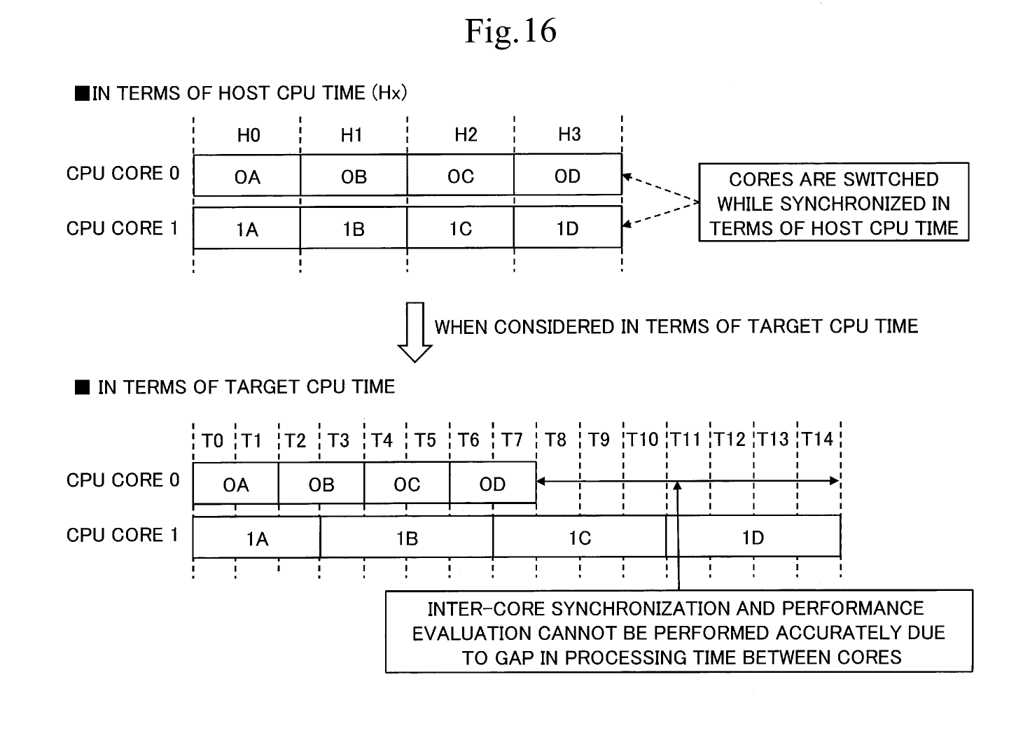

### DESCRIPTION OF EMBODIMENTS

### First Embodiment

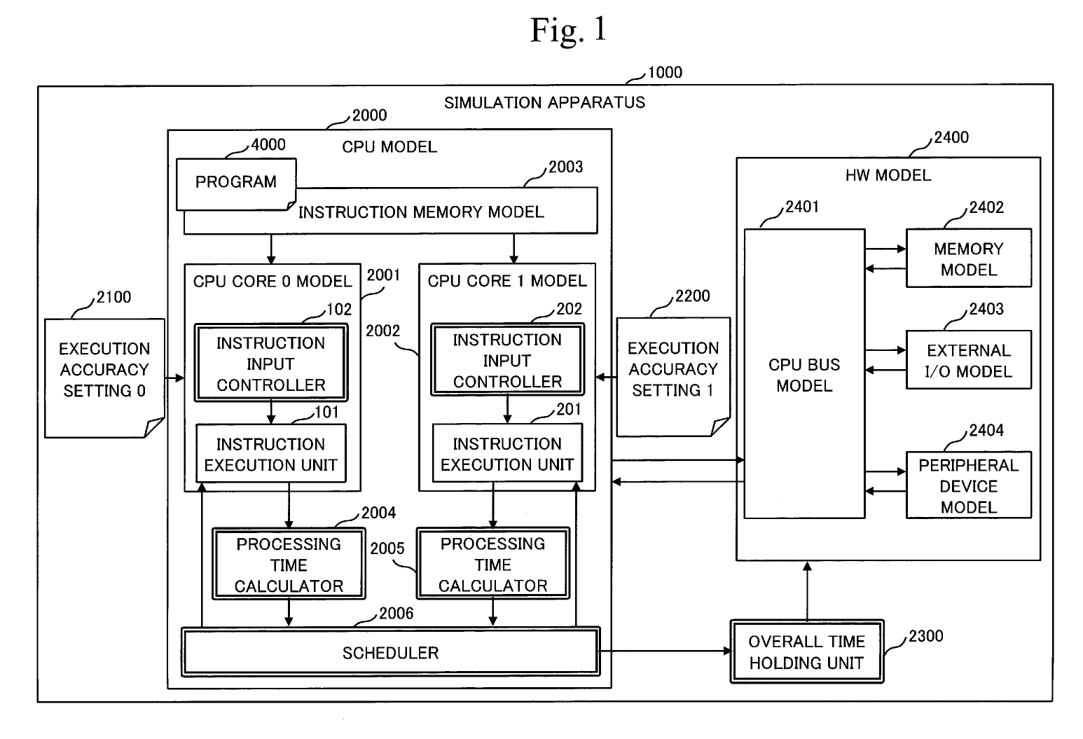

FIG. 1 illustrates the configuration of a simulation apparatus according to a first embodiment of the present invention. Note that in the following figures, the same reference numeral denotes the same or equivalent part.

A simulation apparatus 1000 illustrated in FIG. 1 is configured to simulate a system including two CPU core models, and broadly includes a CPU model 2000, an execution accuracy setting 0 2100, an execution accuracy setting 1 2200, an overall time holding unit 2300, a HW model 2400, and a program 4000 of a SW model. The program 4000 of a SW model is a SW to be verified that is to be run on a target CPU, and runs on the CPU model 2000. At that time, the program 4000 of a SW model is executed upon being converted into a host code. The execution accuracy setting 0 2100 and the execution accuracy setting 1 2200 each set the execution accuracy of processing executed by the CPU model. Here, the execution accuracy can be defined in various forms such as a time unit by which each core is executed, the number of instructions executed by each core, and an operating frequency of each core. The overall time holding unit 2300 holds the time of the entire simulation apparatus 1000.

Moreover, the CPU model 2000 includes a CPU core 0 model 2001, a CPU core 1 model 2002, an instruction memory model 2003, a processing time calculator 2004, a processing time calculator 2005, and a scheduler 2006. The CPU core 0 model 2001 and the CPU core 1 model 2002 are each a functional model simulating a CPU core in a target system. The instruction memory model 2003 is a functional model storing the program 4000 of a SW model. The processing time calculator 2004 and the processing time calculator 2005 calculate processing times of the CPU core 0 model 2001 and the CPU core 1 model 2002, respectively. The scheduler 2006 controls execution of the CPU core 0 model 2001 and the CPU core 1 model 2002 from the processing times calculated by the processing time calculator 2004 and the processing time calculator 2005.

Moreover, the CPU core 0 model 2001 includes an instruction execution unit 101 and an instruction input controller 102, while the CPU core 1 model 2002 includes an instruction execution unit 201 and an instruction input controller 202. The instruction input controllers 102 and 202 control input of instructions executed by the CPU core 0 model 2001 and the CPU core 1 model 2002 on the basis of the settings of the execution accuracy setting 0 2100 and the execution accuracy setting 1 2200, respectively. The instruction execution units 101 and 201 execute instructions input from the instruction input controllers 102 and 202.

Moreover, the HW model 2400 includes a CPU bus model 2401, a memory model 2402, an external I/O model 2403, and a peripheral device model 2404.

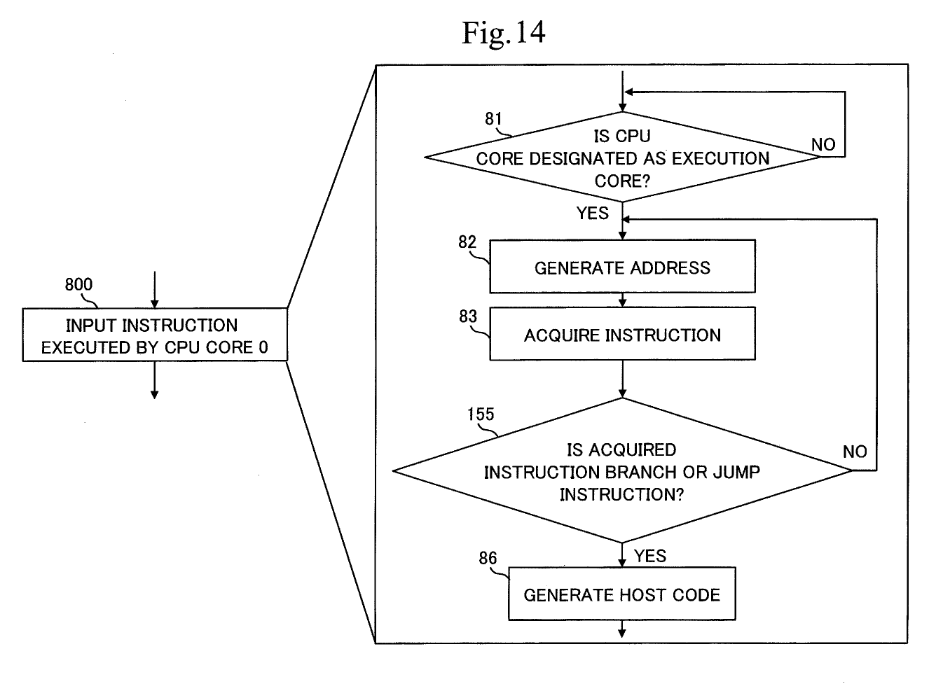

Each of the models is a functional model described in a programming language. These models are modeled using a high-level language such as C language, but the HW model 2400 may be described in a HW description language such as a hardware description language (hereinafter referred to as an HDL) or the like. Note that the configuration of hardware actually implementing the functional models such as the HW model 2400 described in the programming language will be described later with reference to FIG. 14.

The execution accuracy setting 0 2100 sets the accuracy of processing execution for the CPU core 0 model 2001, and the execution accuracy setting 1 2200 sets the accuracy of processing execution for the CPU core 1 model 2002. A processing execution step of each core is set in a corresponding one of the execution accuracy setting 0 2100 and the execution accuracy setting 1 2200. The process executing step sets any one of the number of execution instructions, the number of cycles, and the processing time period.

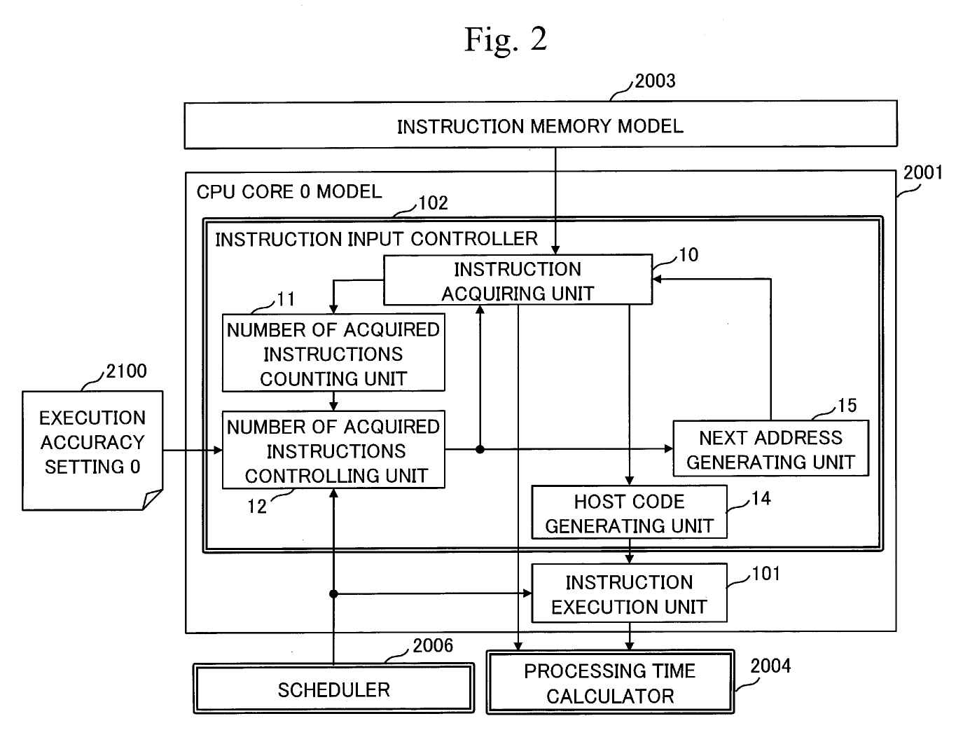

FIG. 2 illustrates a functional block diagram of the instruction input controller 102 in the CPU core 0 model 2001. The instruction input controller 102 includes an instruction acquiring unit 10, a number of acquired instructions counting unit 11, a number of acquired instructions controlling unit 12, a host code generating unit 14, and a next address generating unit 15. The instruction input controller 202 in the CPU core 1 model 2002 also has a configuration similar to that of FIG. 2.

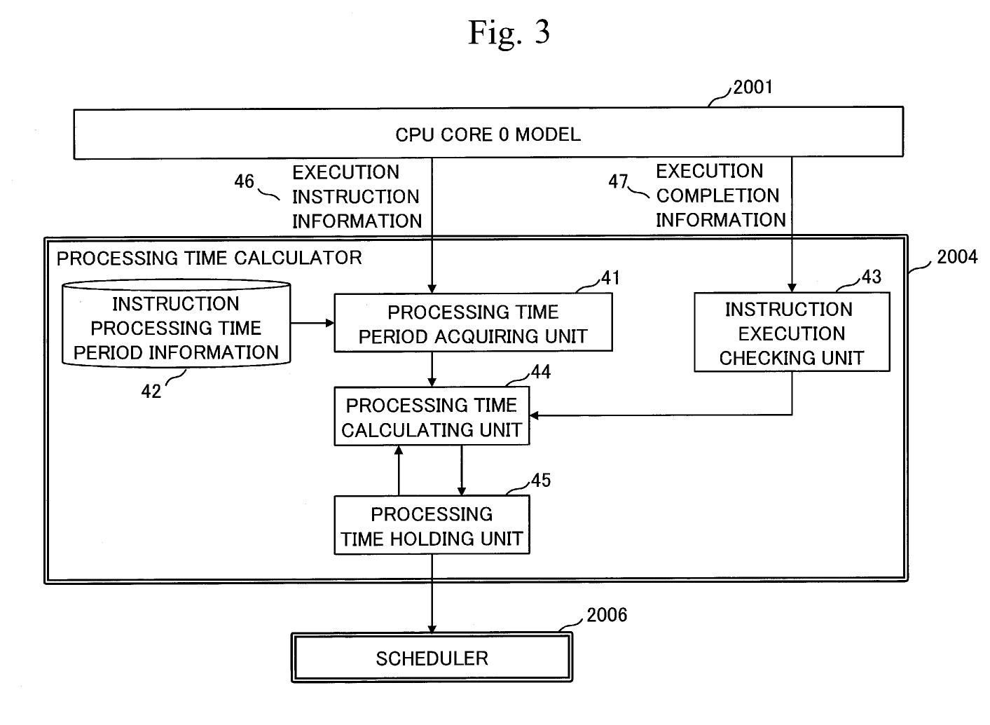

FIG. 3 illustrates a functional block diagram of the processing time calculator 2004. The processing time calculator 2004 includes a processing time period acquiring unit 41, instruction processing time period information 42, an instruction execution checking unit 43, a processing time calculating unit 44, and a processing time holding unit 45. Note that a functional block diagram of the processing time calculator 2005 is similar to the functional block diagram of the processing time calculator 2004.

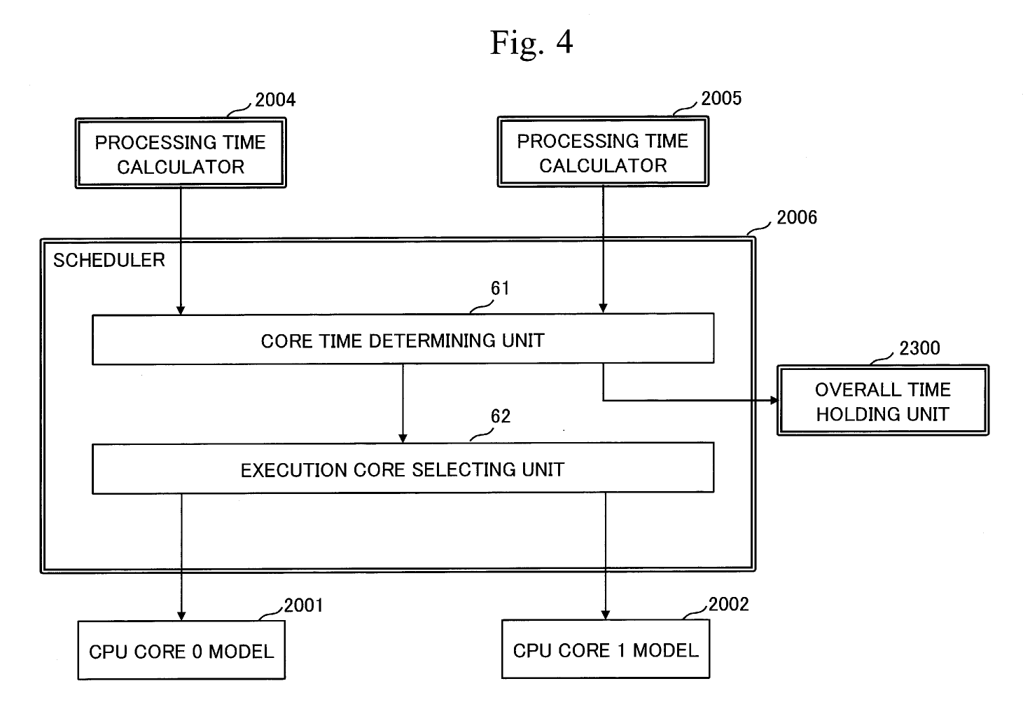

FIG. 4 illustrates a functional block diagram of the scheduler 2006. The scheduler 2006 includes a core time comparing unit 61 and an execution core selecting unit 62.

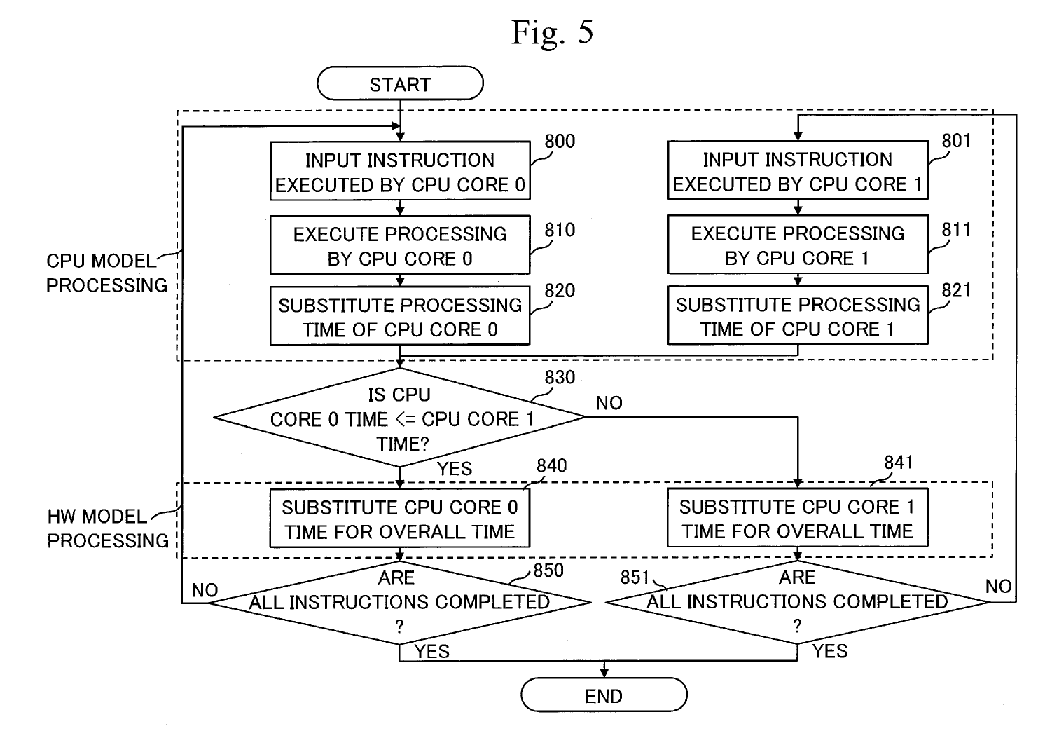

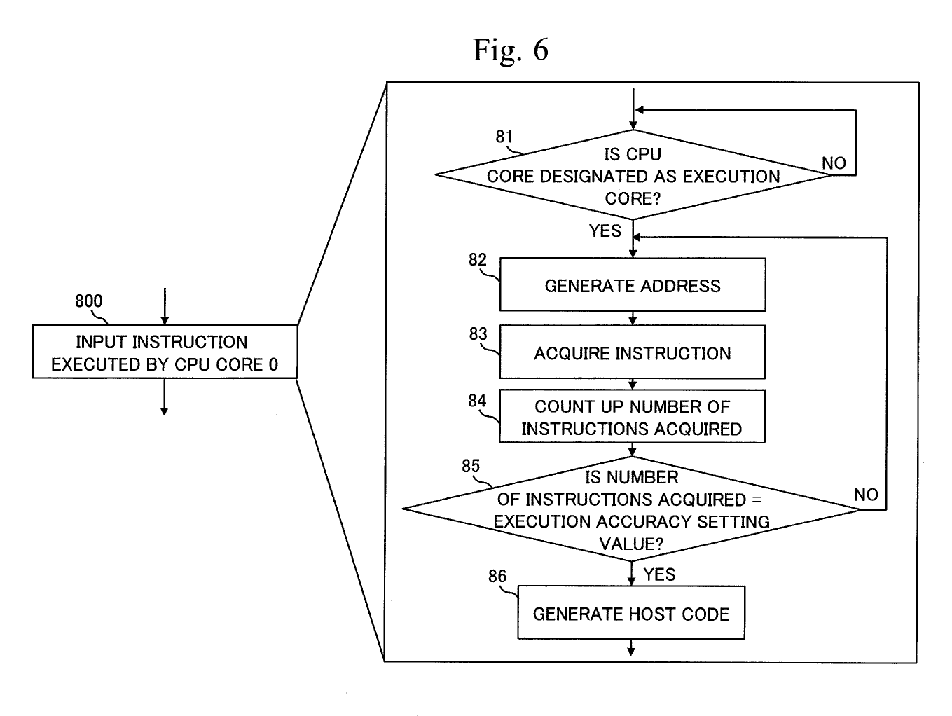

FIGS. 5 and 6 illustrate flowcharts of the simulation apparatus 1000 illustrated in FIG. 1. FIG. 5 is an overall flowchart of the simulation apparatus 1000, and FIG. 6 is a detailed flowchart of step 800 in FIG. 5. The operation of the simulation apparatus illustrated in FIGS. 1 to 4 will be described with reference to FIGS. 5 and 6. For the purpose of description, it is assumed that the operation starts from the CPU core 0.

First, in step 800 of FIG. 5, the CPU core 0 model 2001 acquires an instruction to be executed from the instruction memory model 2003. The instruction input controller 102 in the CPU core 0 model 2001 acquires the instruction from the instruction memory model 2003 on the basis of the flow illustrated in FIG. 6. The instruction input controller 102 acquires the instruction by determining whether the CPU core 0 model 2001 is specified as an execution core by the number of acquired instructions controlling unit 12 (step 81 in FIG. 6) and, if the determination is “yes”, generating an address of a destination at which the instruction is acquired by the next address generating unit 15 (step 82 in FIG. 6). Moreover, the instruction acquiring unit 10 acquires the instruction from the instruction memory model 2003 on the basis of the address being generated (step 83 in FIG. 6), the number of acquired instructions counting unit 11 counts the number of instructions acquired by the instruction acquiring unit 10 (step 84 in FIG. 6), the number of acquired instructions controlling unit 12 checks whether the number of instructions acquired has reached the number of instructions set in the execution accuracy setting 0 2100 (step 85 in FIG. 6), and the instruction acquiring unit 10 acquires a next instruction if the number of instructions acquired has not reached the number of instructions (No in step 85 in FIG. 6) or stops acquiring instructions if the number of instructions acquired has reached the number of instructions (yes in step 85 in FIG. 6) so that the host code generating unit 14 generates host codes corresponding to the instructions acquired (step 86 in FIG. 6) and inputs the host codes to the instruction execution unit 101. The instruction acquiring unit 10 also outputs the instruction (execution instruction information 46 in FIG. 3) which is output to the host code generation 14 to the processing time calculator 2004 at the same timing.

Next, in step 810 of FIG. 5, the instruction execution unit 101 in the CPU core 0 model 2001 executes the host code being input. After executing the instruction, the instruction execution unit 101 outputs execution completion information 47 to the processing time calculator 2004.

In step 820 of FIG. 5, the processing time time calculator 2004 calculates the processing time of the CPU core 0 model 2001 with the execution instruction information 46 and the execution completion information 47 from the CPU core 0 model 2001. The execution instruction processing time period acquisition 41 in the processing time calculator 2004 acquires the processing time period of the instruction executed by the CPU core 0 model 2001 based on the execution instruction information 46 from the CPU core 0 model 2001 and the instruction processing time period information 42. The instruction execution checking unit 43 in the processing time calculator 2004 determines completion of execution of the instruction by the CPU core 0 model 2001 based on the execution completion information 47 from the CPU core 0 model 2001. If the instruction execution checking unit 43 determines that the execution of the instruction is completed, the processing time calculating unit 44 in the processing time calculator 2004 adds the processing time period from the execution instruction processing time period acquisition 41 to the processing time held in the processing time time holding unit 45, and stores the result in the processing time holding unit 45. The processing time holding unit 45 outputs the processing time held therein to the scheduler 2006. Here, for example, the processing time time holding unit 45 can hold the time at which the processor core model executes the instruction as the processing time with a start of the simulation as a starting point.

Next, in step 830 of FIG. 5, the scheduler 2006 compares the processing times of the CPU core 0 model 2001 and the CPU core 1 model 2002. The core time determining unit 61 in the scheduler 2006 determines a core whose time has elapsed less (advanced less) and the processing time of the core between the processing times of the CPU core 0 model 2001 and the CPU core 1 model 2002. The core time determining unit 61 outputs the processing time being determined to the overall time holding unit 2300. The core time determining unit 61 also outputs core information being determined to the execution core selecting unit 62. The execution core selecting unit 62 outputs execution core designating information to the CPU core 0 model 2001 or the CPU core 1 model 2002 on the basis of the core information determined by the core time determining unit 61.

Next, in step 840 of FIG. 5, the overall time holding unit 2300 holds the processing time from the scheduler 2006 and substitutes the processing time of the CPU core 0 model 2001 as the overall processing time.

Next, in step 850 of FIG. 5, the number of acquired instructions control 12 in the CPU core 0 model 2001 instructs the next address generating unit 15 to generate an address on the basis of the execution core designating information from the scheduler 2006, whereby the next address generating unit 15 generates an address of an instruction to be executed next and ends the operation if the program 4000 of the SW model is completed. If the program is not completed, the operation returns to step 800 of FIG. 5 and executes the processing again.

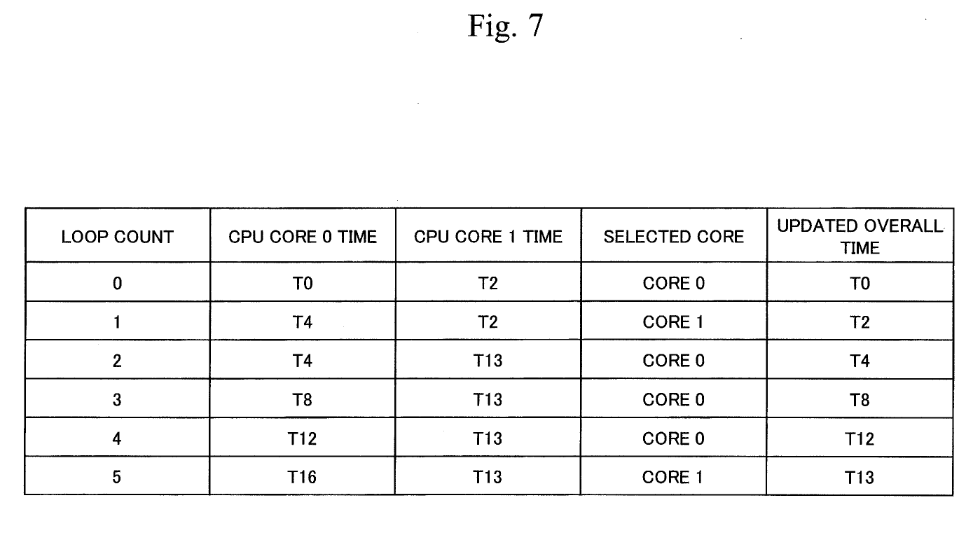

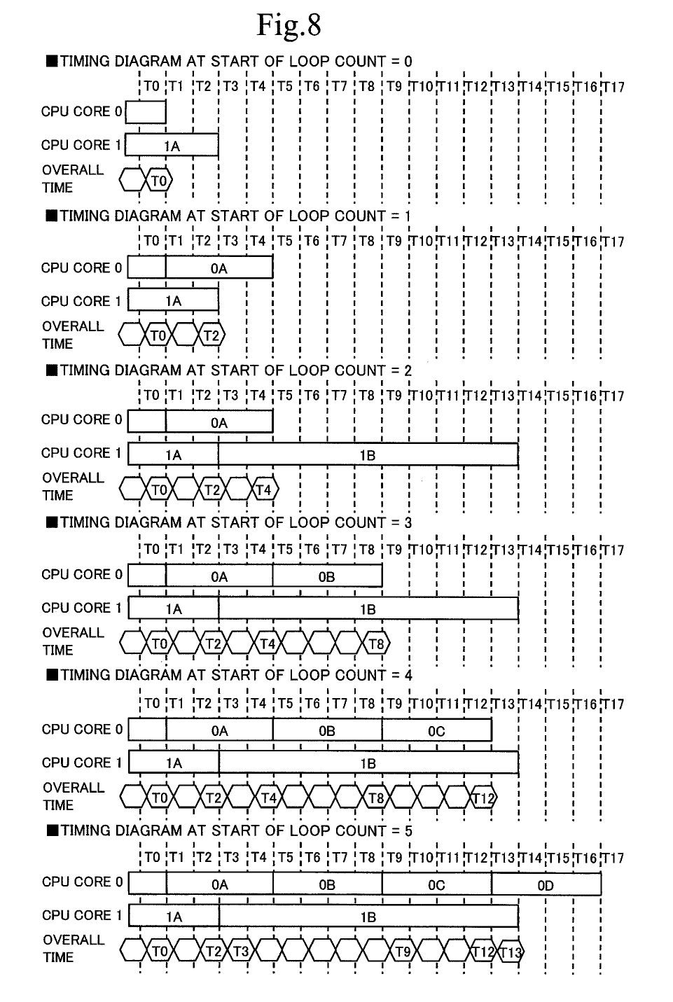

FIGS. 7 and 8 illustrate an example of an inter-core synchronization operation of the simulation apparatus 1000 illustrated in FIG. 1. FIGS. 7 and 8 illustrate the operation after a certain timing (T0) in the middle of the operation. In FIG. 7, a loop count column indicates the number of loops of steps 800 and 801 to steps 850 and 851 in FIG. 5, a CPU core 0 time column indicates the processing time of the CPU core 0 model 2001 held in the processing time calculator 2004, a CPU core 1 time column indicates the processing time of the CPU core 1 model 2002 held in the processing time calculator 2005, a selected core indicates a core that is selected to be executed next by the scheduler 2006 from the output of the processing time calculators 2004 and 2005, and an updated overall time indicates the processing time output from the scheduler 2006 to the overall time managing unit 2300.

In FIG. 8, Tx (x=0 to 17) indicates the processing time period in terms of the target processing time, and an overall time indicates the overall processing time held in the overall processing time holding unit 2300.

First, it is assumed that the execution accuracy setting 0 2100 sets “four instructions” and the execution accuracy setting 1 2200 sets “11 instructions”. Moreover, T1 indicates the processing time period of one instruction for the purpose of description. Processings 0A to 0D are the processings performed by the CPU core 0 model 2001 with the execution accuracy setting 0 2100, and processings 1A to 1C are the processings performed by the CPU core 1 model 2002 with the execution accuracy setting 1 2200. Thus, the processings 0A to 0D each include four instructions, and the processings 1A to 1B each include 11 instructions.

Moreover, in an operation preceding the operation of FIGS. 7 and 8, the scheduler 2006 selects execution of processing of the CPU core 1 model 2002 so that the CPU core 1 model 2002 has already executed the processing 1A. The processing time calculator 2005 has then calculated the processing time of the processing 1A after completion of the processing 1A by the CPU core 1 model 2002 and added the calculated processing time to the processing time of the CPU core 1 model 2002, so that the processing time of the CPU core 1 model 2002 is already at T2. At this time, the scheduler 2006 determines the magnitude relation between the processing time T0 of the CPU core 0 model 2001 and the processing time T2 of the CPU core 1 model 2002, and selects the CPU core 0 model 2001 as one that executes the processing next. The overall processing time is T0 since the processing time of the CPU core 0 model 2001 is substituted.

At the loop count=1 in FIG. 7, the simulation apparatus 1000 is in a state in which the CPU core 0 model 2001 is selected as the execution core according to the above assumption. Thus, at the loop count=1, the CPU core 0 model 2001 executes the processing 0A so that the processing time of the CPU core 0 model 2001 advances from T0 to T4. After the CPU core 0 model 2001 completes the execution of the processing 0A, the scheduler 2006 compares the processing time T4 of the CPU core 0 model 2001 with the processing time T2 of the CPU core 1 model 2002, and selects the CPU core 1 model 2002 with a less lapse of time as a next execution core. Moreover, the overall processing time managing unit 2300 holds the processing time T2 of the CPU core 1 model 2002 as the overall processing time.

At the loop count=2 in FIG. 7, not all the instructions are completed by the processing 0A so that the CPU core 1 model 2002 executes the processing 1B and that the processing time of the CPU core 1 model 2002 advances from T2 to T13. After the CPU core 1 model 2002 completes the execution of the processing 1B, the scheduler 2006 compares the processing time T4 of the CPU core 0 model 2001 with the processing time T13 of the CPU core 1 model 2002, and selects the CPU core 0 model 2001 with a less lapse of time as a next execution core. Moreover, the overall processing time managing unit 2300 holds the processing time T4 of the CPU core 0 model 2001 as the overall processing time.

At the loop count=3 in FIG. 7, not all the instructions are completed by the processing 1B so that the CPU core 0 model 2001 executes the processing 0B and that the processing time of the CPU core 0 model 2001 advances from T4 to T8. After the CPU core 0 model 2001 completes the execution of the processing 0B, the scheduler 2006 compares the processing time T8 of the CPU core 0 model 2001 with the processing time T13 of the CPU core 1 model 2002, and selects the CPU core 0 model 2001 with a less lapse of time as a next execution core. Moreover, the overall processing time managing unit 2300 holds the processing time T8 of the CPU core 0 model 2001 as the overall processing time.

At the loop count=4 in FIG. 7, not all the instructions are completed by the processing 0B so that the CPU core 0 model 2001 executes the processing 0C and that the processing time of the CPU core 0 model 2001 advances from T8 to T12. After the CPU core 0 model 2001 completes the execution of the processing 0C, the scheduler 2006 compares the processing time T12 of the CPU core 0 model 2001 with the processing time T13 of the CPU core 1 model 2002, and selects the CPU core 0 model 2001 with a less lapse of time as a next execution core. Moreover, the overall processing time managing unit 2300 holds the processing time T12 of the CPU core 0 model 2001 as the overall processing time.

At the loop count=5 in FIG. 7, not all the instructions are completed by the processing 0C so that the CPU core 0 model 2001 executes the processing 0D and that the processing time of the CPU core 0 model 2001 advances from T12 to T16. After the CPU core 0 model 2001 completes the execution of the processing 0D, the scheduler 2006 compares the processing time T16 of the CPU core 0 model 2001 with the processing time T13 of the CPU core 1 model 2002, and selects the CPU core 1 model 2002 with a less lapse of time as a next execution core. Moreover, the overall processing time managing unit 2300 holds the processing time T16 of the CPU core 0 model 2001 as the overall processing time.

In the next loop, the CPU core 1 model 2002 selected at the loop count=5 executes the processing if not all the instructions are completed by the processing 0D. The simulation apparatus 1000 ends the operation if all the instructions are completed by the processing 0D.

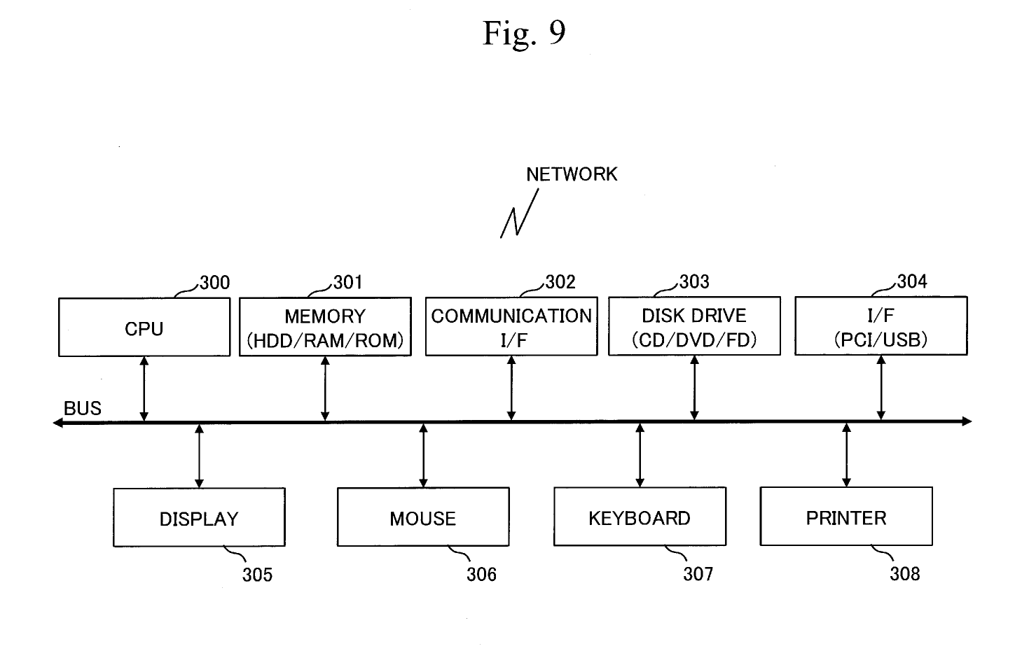

FIG. 9 illustrates an example of the configuration of hardware constructing the simulation apparatus according to the first embodiment of the present invention. The simulation apparatus constructed by the hardware configuration illustrated in FIG. 9 includes a CPU 300 and a memory (Hard Disk Drive (HDD)/Random Access Memory (RAM)/Read Only Memory (ROM)) 301. The simulation apparatus also includes a communication interface (I/F) 302, a disk drive (Compact Disc (CD)/Digital Versatile Disc (DVD)/Floppy Disk (FD)) 303, and an I/F (Peripheral Component Interconnect (PCI)/Universal Serial Bus (USB)) 304. The simulation apparatus further includes a display 305, a mouse 306, a keyboard 307, and a printer 308. Instead of the mouse 306, a touch panel, a touch pad, a track ball, a pen tablet, or another pointing device may be used. Moreover, the CPU 300 to the printer 308 are connected via a bus 309.

The CPU 300 is an example of a processor to control the entire simulation apparatus and execute a program. The memory 301 is the ROM or HDD being a nonvolatile memory storing a program such as a boot program and a program representing the functional models illustrated in the first to third embodiments, and the RAM used as a work area of the CPU 300 or the like.

The communication I/F 302 is connected to a network and allows the simulation apparatus to be controlled via the network. The network may be a wide area network (WAN) such as an Internet Protocol Virtual Private Network (IP-VPN), a wide area LAN, or an asynchronous transfer mode (ATM) network, or the Internet. The LAN, WAN, and the Internet are examples of the network. The disk drive 303 is a device that controls read and write of data from/to a disk. The I/F 304 is a device that connects devices other than the one illustrated in FIG. 14 to the bus 309 via the PCI or USB for use as a part of the simulation apparatus.

As described above, in the simulation of the system including the multiple CPUs or multiple cores, the multiple CPUs or cores can be synchronized accurately and at high speed while the CPUs or cores are operated with different execution accuracies. Moreover, the use of the present simulation apparatus enables an accurate performance evaluation of the system including the multiple CPUs or multiple cores.

As described above, the simulation apparatus 1000 of the multi-core model according to the first embodiment includes: the plurality of processor core models represented by the CPUI core 0 model 2001 and the CPU core 1 model 2002 that execute the instructions being input; the processing time calculators 2004 and 2005 that calculate the time at which each of the plurality of core models executes the instruction as the processing time; the scheduler 2006 that selects a processor core model to be executed next from the plurality of processor core models represented by the CPUI core 0 model 2001 and the CPU core 1 model 2002 on the basis of the processing time calculated by the processing time calculators 2004 and 2005; and the overall time holding unit 2300 that holds the processing time of the entire apparatus determined from the processing time calculated by the processing time calculator 2005. The processor core model selected by the scheduler 2006 executes a next instruction in accordance with the direction from the scheduler 2006. With such a configuration, the simulation apparatus 1000 of the multi-core model can maintain the accuracy of synchronization between the multiple CPUs or multiple cores and perform an accurate performance evaluation while executing the multiple CPUs or multiple cores with different execution accuracies in simulating the system including the multiple CPUs or multiple cores.

Moreover, in the simulation apparatus 1000 of the multi-core model according to the first embodiment, the scheduler 2006 includes: the core time determining unit 61 which is a determining unit that determines a processor core model with the least lapse of time among the plurality of processor core models on the basis of the processing time calculated by the processing time calculator 2005; and the execution core selecting unit 62 which is a selecting unit that selects the processor core model determined by the core time determining unit 61 as a processor core model to be executed next. Such a configuration can perform control to advance the time of the processor core model with the least lapse of time and increase the accuracy of synchronization among the plurality of processor core models by reducing the difference in the processing times among the plurality of processor core models.

Moreover, in the simulation apparatus 1000 of the multi-core model according to the first embodiment, the CPUI core 0 model 2001 and the CPU core 1 model 2002 being the processor core models include the instruction input controllers 102 and 202 that generate the host codes from the instructions being input, and the instruction execution units 101 and 201 that execute the host codes generated by the instruction input controllers 102 and 202, respectively. Such a configuration includes the instruction input controller 102 that generates the host code from the instruction being input and the instruction execution unit 101 that executes the host code generated by the instruction input controller 102. Such a configuration can convert the instruction being input with the set accuracy into the host code and execute the instruction by the set processing unit.

The simulation apparatus 1000 of the multi-core model according to the first embodiment further includes an execution accuracy setting unit represented by the execution accuracy setting 0 2100 and the execution accuracy setting 1 2200 that set the execution accuracy of the corresponding CPUI core 0 model 2001 and CPU core 1 model 2002 being the plurality of processor core models. The instruction input controllers 102 and 202 each generate the host code from the instruction being input on the basis of the execution accuracy set by the execution accuracy setting unit. Such a configuration can individually set the accuracy for the CPUI core 0 model 2001 and the CPU core 1 model 2002 being the plurality of processor core models.

Moreover, the execution accuracy set in the simulation apparatus 1000 of the multi-core model according to the first embodiment is any one of the number of instructions, the number of cycles, the processing time period, and the type of the instruction. Such a configuration can set the unit of execution of the instruction being input on the basis of the number of instructions, the number of cycles, the processing time period, or the type of the instruction.

Moreover, in the simulation apparatus 1000 of the multi-core model according to the first embodiment, the processing time calculators 2004 and 2005 each include the processing time period acquiring unit 41 that acquires the execution processing time period of the instruction executed by the processor core model, and the processing time calculating unit 44 that calculates, with the start of the simulation as the starting point, the time at which the processor core model executes the instruction as the processing time on the basis of the execution processing time period acquired by the processing time period acquiring unit 41. Such a configuration can measure the execution processing time period of the instruction executed by the processor core model for each execution unit and calculate an appropriate processing time for each execution unit.

Moreover, in the simulation apparatus 1000 of the multi-core model according to the first embodiment, the overall time holding unit 2300 holds the processing time of the processor core model selected by the scheduler 2006 as the processing time of the entire apparatus. Such a configuration allows the processing time of the entire apparatus to be synchronized with the processing time of the processor core model selected by the scheduler 2006.

Moreover, in the simulation apparatus 1000 of the multi-core model according to the first embodiment, the overall time holding unit 2300 holds the processing time of the processor core model selected by the scheduler 2006 as the processing time of the entire apparatus. Such a configuration allows the processing time of the entire apparatus to be synchronized with the processing time of the processor core model selected by the scheduler 2006.

### Second Embodiment

The first embodiment mainly illustrates the configuration in the case where the number of instructions is set as the execution accuracy setting 0, whereas the present embodiment illustrates a configuration in the case where the processing time period or the number of cycles is set as the execution accuracy setting 0.

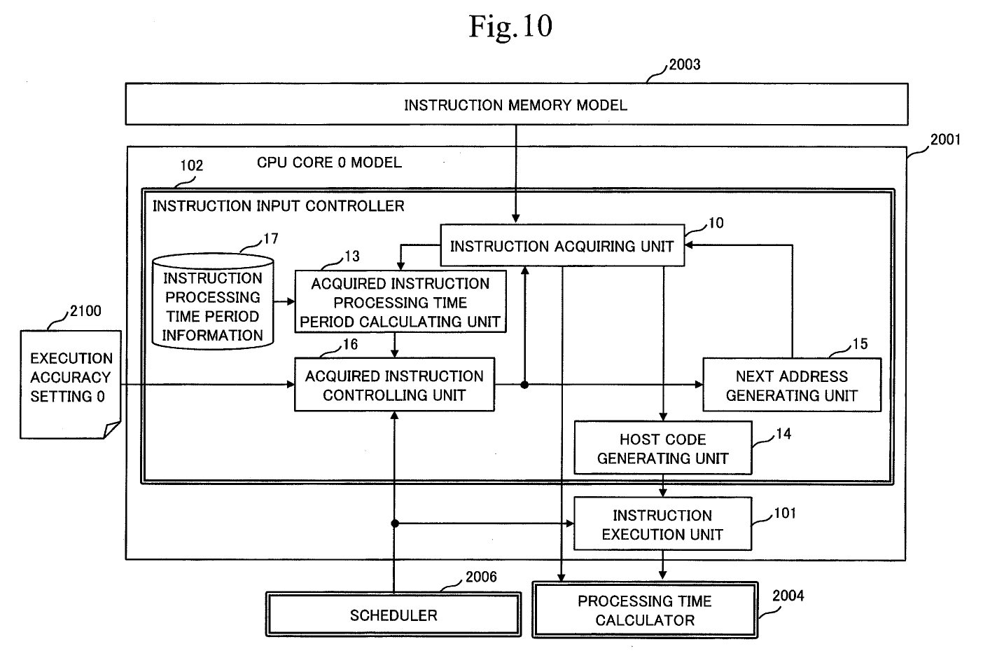

FIG. 10 illustrates a functional block diagram of the instruction input controller 102 according to a second embodiment of the present invention.

The instruction input controller 102 illustrated in FIG. 10 corresponds to the case where the processing time period or the number of cycles is set as the execution accuracy setting 0, and has the configuration in which instruction processing time period information 17 is added to the instruction input controller 102 of the first embodiment illustrated in FIG. 2, the number of acquired instructions counting unit 11 is replaced with an acquired instruction processing time period calculating unit 13, and the number of acquired instructions control 12 is replaced with an acquired instruction controlling unit 16.

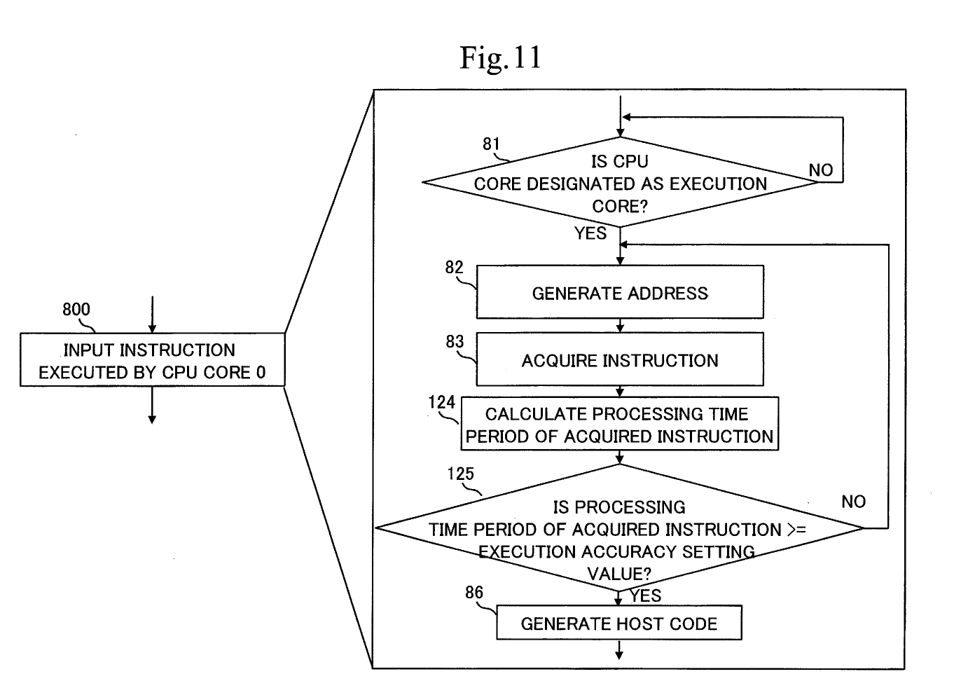

FIG. 11 illustrates a detailed flowchart of step 800 in FIG. 5 according to the second embodiment of the present invention. The differences from the flowchart of the first embodiment illustrated in FIG. 6 are that “count up the number of instructions acquired” in step 84 is changed to “calculate processing time period of an acquired instruction” in step 124 and that the condition “the number of instructions acquired==the execution accuracy setting value” in step 85 is changed to a condition “processing time period of the acquired instruction>=the execution accuracy setting value” in step 125. The determination is made on the basis of the processing time period in FIG. 11 but may be made on the basis of the number of cycles. In that case, the number of cycles is specified as the execution accuracy setting value.

The operation of the simulation apparatus according to the second embodiment will be described with reference to FIGS. 10 and 11 while focusing only on the differences from the operation in the first embodiment illustrated in FIGS. 2 and 6.

In step 800 of FIG. 5, the CPU core 0 model 2001 acquires an instruction to be executed from an instruction memory. The instruction input controller 102 in the CPU core 0 model 2001 acquires the instruction on the basis of the flowchart illustrated in FIG. 11.

In the flowchart illustrated in FIG. 11, the operations in steps 81 to 83 are similar to those of the first embodiment. In step 124, the acquired instruction processing time period calculating unit 13 acquires processing time period of the instruction acquired in step 83 from the instruction processing time period information 17, and calculates the processing time period. In step 125, the acquired instruction controlling unit 16 compares the processing time period calculated in step 124 with an execution accuracy setting value set by the execution accuracy setting 0 2100 so that the instruction acquiring unit 10 stops acquiring instructions if the processing time period of the acquired instruction is longer than or equal to the execution accuracy setting value, or acquires a next instruction if the processing time period of the acquired instruction is shorter than the execution accuracy setting value. The operations in step 86 and the flow after step 810 are similar to those of the first embodiment.

The way a multi-core simulation is performed by the simulation apparatus of the second embodiment is similar to that in FIGS. 7 and 8.

As described above, the simulation apparatus according to the second embodiment performs the simulation of the system including the multiple CPUs or multiple cores such that the multiple CPUs or cores can be synchronized accurately and at high speed while the CPUs or cores are operated with different execution accuracies without limiting threads executed by the multiple CPUs or cores. Moreover, the use of the present simulation apparatus enables an accurate performance evaluation of the system including the multiple CPUs or multiple cores.

Note that the first and second embodiments may include one thread in the program 4000 or have a multi-thread configuration including a plurality of programs. The configurations described in the first and second embodiments can also be applied to the case where the program 4000 includes multiple threads.

### Third Embodiment

The first and second embodiments receive the execution accuracy setting value such as the number of instructions, the processing time period, or the number of cycles from outside the core 0 model 2001 or the core 1 model 2002 to control the processing performed by each core on the basis of the accuracy setting. On the other hand, the present embodiment illustrates a configuration in which one branch included in a program is treated as one unit and each branch instruction as the unit of execution independent of the setting from outside the core 0 model 2001 or the core 1 model 2002.

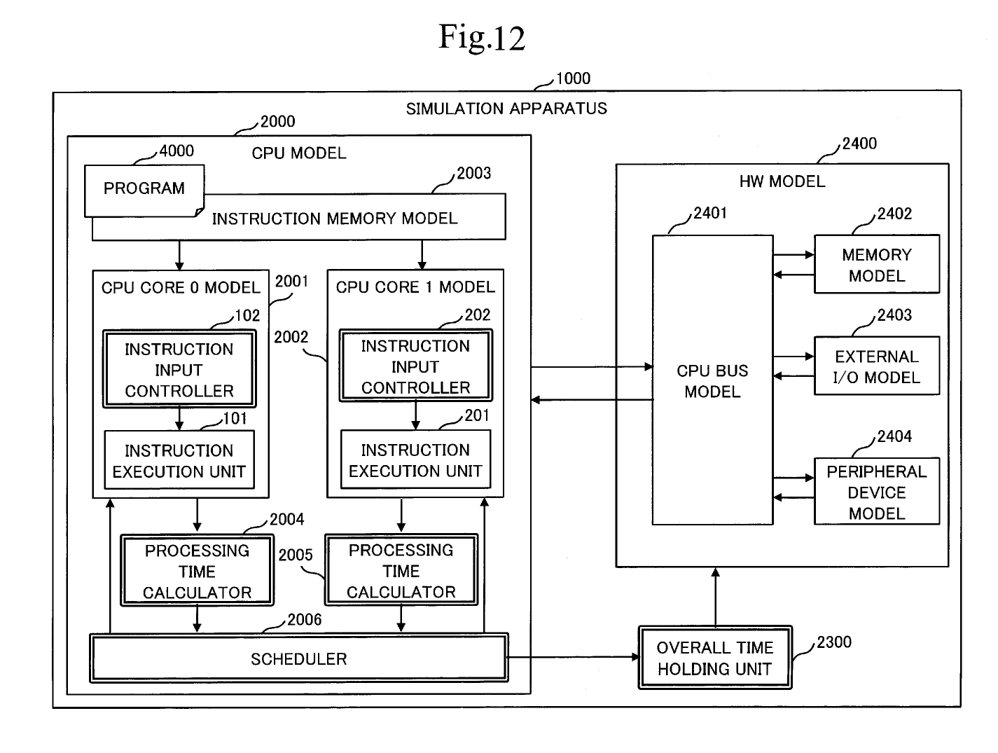

FIG. 12 illustrates the configuration of the simulation apparatus according to a third embodiment of the present invention. The simulation apparatus illustrated in FIG. 12 has a configuration in which the execution accuracy setting 0 2100 and the execution accuracy setting 1 2200 are removed from the simulation apparatus illustrated in FIG. 1.

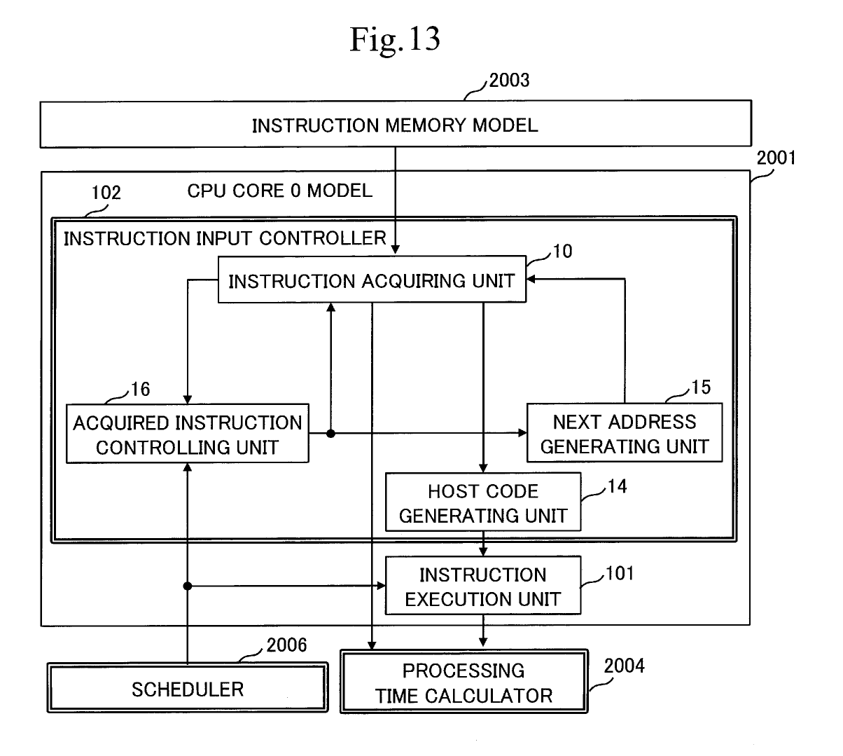

FIG. 13 illustrates a functional block diagram of the instruction input controller 102 according to the third embodiment of the present invention. The instruction input controller 102 illustrated in FIG. 13 has a configuration in which the instruction processing time period information 17 and the acquired instruction processing time period calculating unit 13 are removed from the instruction input controller 102 of the second embodiment illustrated in FIG. 10.

FIG. 14 illustrates a detailed flowchart of step 800 in FIG. 5 according to the third embodiment of the present invention. The differences from the flowchart of the first embodiment illustrated in FIG. 6 are that step 84 is removed, and the condition “the number of instructions acquired==the execution accuracy setting value” in step 85 is changed to a condition “is the acquired instruction a branch or jump instruction?” in step 155.

The operation of the simulation apparatus according to the second embodiment illustrated in FIG. 12 will be described with reference to FIGS. 13 and 14 while focusing only on the differences from the operation in the first embodiment illustrated in FIGS. 2 and 6.

In step 800 of FIG. 5, the CPU core 0 model 2001 acquires an instruction to be executed from an instruction memory. The instruction input controller 102 in the CPU core 0 model 2001 acquires the instruction on the basis of the flowchart illustrated in FIG. 14.

The operations in steps 81 to 83 are similar to those of the first embodiment. In step 155, the acquired instruction controlling unit 16 determines whether the instruction acquired in step 83 is a branch instruction or a jump instruction so that the instruction acquiring unit 10 stops acquiring instructions if the acquired instruction is the branch instruction or jump instruction, or acquires a next instruction if the acquired instruction is not the branch instruction or jump instruction. The operations in step 86 and the flow after step 810 are similar to those of the first embodiment.

FIGS. 13 and 14 determine whether the acquired instruction is the branch instruction or jump instruction. However, when an instruction is to be added to the determination condition or the instruction in the determination condition is to be changed, the determination condition may be changed by an execution accuracy setting. In that case, the execution accuracy setting is added to the simulation apparatus illustrated in FIG. 12.

As described above, in the simulation apparatus 1000 of the multi-core model according to the third embodiment, the processor core models such as the CPUI core 0 model 2001 and the CPU core 1 model 2002 execute the instruction being input with the branch instruction as one unit. Such a configuration allows the processor core models such as the CPUI core 0 model 2001, the CPU core 1 model 2002, and the like to execute the processing while determining the execution accuracy independently of the setting from the outside.

### REFERENCE SIGNS LIST

10: instruction acquiring unit, 11: number of acquired instructions counting unit, 12: number of acquired instructions controlling unit, 14: host code generating unit, 15: next address generating unit, 16: acquired instruction controlling unit, 17: instruction processing time period information, 41: processing time period acquiring unit, 42: instruction processing time period information, 43: instruction execution checking unit, 44: processing time calculator, 45: processing time holding unit, 46: execution instruction information, 47: execution completion information, 61: core time comparing unit, 62: execution core selecting unit, 101, 201: instruction execution unit, 102, 202: instruction input controller, 300: CPU, 301: memory (Hard Disk Drive (HDD)/Random Access Memory (RAM)/Read Only Memory (ROM)), 302: communication interface (I/F), 303: disk drive (Compact Disc (CD)/Digital Versatile Disc (DVD)/Floppy Disk (FD)), 304: I/F (Peripheral Component Interconnect (PCI)/Universal Serial Bus (USB)), 305: display, 306: mouse, 307: keyboard, 308: printer, 308: printer, 309: bus, 1000: simulation apparatus, 2000: CPU model, 2001: CPU core 0 model, 2002: CPU core 1 model, 2003: instruction memory model, 2004: processing time calculator, 2005: processing time calculator, 2006: scheduler, 2100: execution accuracy setting 0, 2200: execution accuracy setting 1, 2300: overall time holding unit, 2400: HW model, 2401: CPU bus model, 2402: memory model, 2403: external I/O model, 2404: peripheral device model, 4000: program, 6000: simulator apparatus, 6001: CPU core 0 model, 6002: CPU core 1 model, 6003: CPU bus model, 6004: external I/O model, 6005: peripheral model, 6006: memory model, 7000: SW model.

1-8. (canceled)

9. A simulation apparatus of a multi-core model comprising:
processing circuitry to:
calculate time at which each of a plurality of processor core models executes an instruction as processing time, the plurality of processor core models each being a program including an instruction input controller that generates a host code from an instruction being input and an instruction execution unit that executes the host code generated by the instruction input controller;
select a processor core model with the least lapse of time as a processor core model to be executed next from among the plurality of processor core models on the basis of the calculated processing time; and
hold processing time of the entire simulation apparatus determined from the calculated processing time, wherein
the processing circuitry causes the selected processor core model to execute a next instruction.

10. The simulation apparatus of a multi-core model according to claim 9, wherein the processing circuitry sets execution accuracy of each of the plurality of processor core models, and generates the host code from the instruction being input on the basis of the execution accuracy that has been set.

11. The simulation apparatus of a multi-core model according to claim 10, wherein the execution accuracy is any one of the number of instructions, the number of cycles, processing time period, and a type of instruction.

12. The simulation apparatus of a multi-core model according to claim 9, wherein the processing circuitry holds processing time of the selected processor core model as the processing time of the entire simulation apparatus.

13. The simulation apparatus of a multi-core model according to claim 10, wherein the processing circuitry holds processing time of the selected processor core model as the processing time of the entire simulation apparatus.

14. The simulation apparatus of a multi-core model according to claim 11, wherein the processing circuitry holds processing time of the selected processor core model as the processing time of the entire simulation apparatus.
